(19) United States
(12) Patent Application Publication
(10) Pub. No.: US 2007/0186125 A1
(43) Pub. Date: Aug. 9, 2007

(54) Electronic circuit and method for operating an electronic circuit

(76) Inventor: Marjan Radin-Macukat, Nuernberg (DE)

Correspondence Address: MCGRATH, GEISSLER, OLDS & RICHARDSON, PLLC, P.O. BOX 1364, FAIRFAX, VA, 22038-1364, US

(21) Appl. No.: 11/599,398

(22) Filed: Nov. 15, 2006

(30) Foreign Application Priority Data
Nov. 15, 2005 (DE) DE102005054347.2

(51) Int. Cl. G06F 1/00

(52) U.S. Cl. 713/500

(57) ABSTRACT

An electronic circuit is disclosed, having a primary circuit that processes at least one information signal with a predefinable frequency, and having a peripheral clock generator for supplying at least one secondary circuit with a peripheral clock signal. A frequency of the peripheral clock signal is chosen as a function of the information signal, in particular as a function of a frequency of the information signal.

This nonprovisional application claims priority under 35 U.S.C. § 119(a) on German Patent Application No. DE 102005054347, which was filed in Germany on Nov. 15, 2005, and which is herein incorporated by reference.

### BACKGROUND OF THE INVENTION

1. Field of the Invention

The present invention relates to an electronic circuit having a primary circuit that processes at least one information signal with a predefinable frequency, and having a peripheral clock generator for supplying at least one secondary circuit with a peripheral clock signal. In addition, the invention relates to a method for operating an electronic circuit.

2. Description of the Background Art

Circuits of the aforementioned type are, in particular, used in the form integrated circuits in modern communication devices, for example, cellular phones, wherein the primary circuit takes on, e.g., general control functions as well as the control of a preferably radio-based communications interface, while the secondary circuit or circuits that may be present implement additional functions. For example, the information signal can be a baseband signal that, after appropriate modulation, is provided for transmission through the radio-based communications interface. The baseband signal can also be an already-modulated signal or another bandpass signal.

One problem with conventional circuits is that the peripheral clock signal produced by the peripheral clock signal generator can interfere with the information signal processed by the primary circuit. Furthermore, since the peripheral clock signal, like almost all other signals used in digital circuits, usually takes the form of a square-wave signal, the interfering influence of the peripheral clock signal is not limited to information signals having the same frequency. Instead, the spectrum of a square-wave peripheral clock signal has a bandwidth that is not negligible, so that even information signals whose frequency is different from the frequency of the peripheral clock signal can be interfered with.

Harmonics of the peripheral clock signal, in particular, commonly have frequencies that extend into the frequency ranges of the information signals used for radio communication, so that primary circuits embodied, for example, as high-frequency transceivers, can be interfered with by the harmonics of the peripheral clock signal. In this way, even the radio channels used by the high-frequency transceivers can be blocked by the aforementioned disadvantageous inherent interference.

As a remedy for such inherent interference with the primary circuit by the peripheral clock signal, it has already been proposed to subject the peripheral clock signal to a frequency modulation. This technique is also known under the name “clock dithering,” and requires a relatively complex control of a suitable clock generator to achieve the aforementioned frequency modulation, for which reason the production costs for such systems are relatively high.

Another disadvantage of systems operating on the principle of clock dithering is that for especially wideband information signals, such as are obtained in the WCDMA method (wideband code division multiple access), a frequency shift of the peripheral clock signal obtained on the basis of clock dithering is not sufficient to preclude an overlap between the frequencies of the peripheral clock signal and the information signal, at least at certain times.

Further efforts to reduce such inherent interference provide design measures such as, e.g., the application of shielding; however, these methods are not usable or are only usable to a limited degree, especially for components accessible to a user, and moreover involve increased weight or increased design complexity.

### SUMMARY OF THE INVENTION

It is therefore an object of the present invention to provide an electronic circuit and a corresponding operating method such that the described inherent interference with the primary circuit by the peripheral clock signal is reduced.

According to the invention, this object is attained in an electronic circuit in that a frequency of the peripheral clock signal is chosen as a function of the information signal, in particular as a function of a frequency of the information signal.

As a result of the choice of the frequency of the peripheral clock signal as a function of the information signal, it is possible, for example, to set the frequency of the peripheral clock signal so as to result in the smallest possible interference effect on the information signal. This means that a significant reduction in the inherent interference of the inventive electronic circuit can be achieved simply by choosing a suitable frequency for the peripheral clock signal, so that complicated shielding measures can be dispensed with.

In an embodiment of the circuit, the frequency of the peripheral clock signal is chosen such that the frequency of at least one harmonic of the peripheral clock signal does not fall below a predefinable frequency difference from the frequency of the information signal. By this means it is ensured that even the harmonics of the peripheral clock signal, which generally takes the form of a square-wave signal in digital circuits, causes the least possible interference with the information signal.

In another embodiment of the invention, the circuit has a primary clock generator to supply the primary circuit with a reference clock signal. In addition to supplying the primary circuit, the reference clock signal of the primary clock generator can also be used to supply the peripheral clock generator, so that the peripheral clock generator can produce the peripheral clock signal from the reference clock signal in a manner known per se, for example by programmable frequency dividers or the like.

Alternatively or in addition to the primary clock generator, the circuit or the primary circuit can also be provided with a reference clock signal that originates from an external source such as, for example, an external RC oscillator or even a quartz crystal oscillator.

It is also possible for the primary clock generator to have an oscillator, especially a quartz crystal oscillator.

In a further embodiment, the primary clock generator can also have a phase lock loop, which is used to particular advantage in conjunction with a voltage-controlled oscillator (VCO).

In yet another embodiment, the peripheral clock generator can have a voltage-controlled oscillator, so that a frequency of the peripheral clock signal generated by the peripheral clock generator can be set in an especially simple manner by selecting a suitable control voltage for the voltage-controlled oscillator.

In addition, the peripheral clock generator can advantageously have a phase lock loop to control its voltage-controlled oscillator in a conventional manner.

In another embodiment of the present invention, at least one secondary circuit can be provided. Such secondary circuits can be designed, for example, as application specific integrated circuits (ASIC), and can serve, e.g., to implement functionalities that preferably are not integrated into the primary circuit for technical or economic reasons.

In an embodiment of the primary circuit as a control unit or signal processing unit, e.g. for a mobile telephone, there are typical functionalities that are provided by secondary circuits, for example in implementing memory interfaces to internal or external mass storage or removable storage media, multimedia functions, especially for controlling LCD displays or other output devices, and the like.

In another embodiment of the present invention, the peripheral clock signal can be supplied to at least two secondary circuits. Since the peripheral clock signal has already been chosen according to the invention in terms of its frequency so as to produce the smallest possible interference with the information signal processed by the primary circuit, it is in principle possible to supply any desired number of secondary circuits with the peripheral clock signal without the need to provide separate measures to suppress inherent interference for each secondary circuit, as is the case with many prior art approaches.

As an additional way of attaining the object of the present invention, in a method for operating an electronic circuit having a primary circuit that processes at least one information signal with predefinable frequency, and having a secondary clock generator for supplying at least one secondary circuit with a peripheral clock signal, provision is made that a frequency of the peripheral clock signal is chosen as a function of the information signal, in particular as a function of a frequency of the information signal.

In another embodiment of the present invention, the frequency of the peripheral clock signal can be specified by the primary circuit. This makes it possible for an adjustment of the frequency of the peripheral clock signal to be undertaken even during operation of the electronic circuit.

Such a dynamic adjustment of the frequency of the peripheral clock signal can be accomplished in that the primary circuit changes a control voltage acting on a voltage-controlled oscillator of the peripheral clock generator and thus directly changes the frequency of the peripheral clock signal.

Moreover, it is useful to choose the frequency of the peripheral clock signal as a function of an operating state of the primary circuit. This method can be employed when the information signal processed by the primary circuit has a frequency that changes with time, or when the primary circuit processes multiple information signals with different frequencies, as is the case with a transceiver that processes transmit and receive signals from different frequency ranges or radio channels, for example.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a first embodiment of the inventive circuit, and

FIG. 2 is a flow chart that illustrates an embodiment of the inventive method.

### DETAILED DESCRIPTION

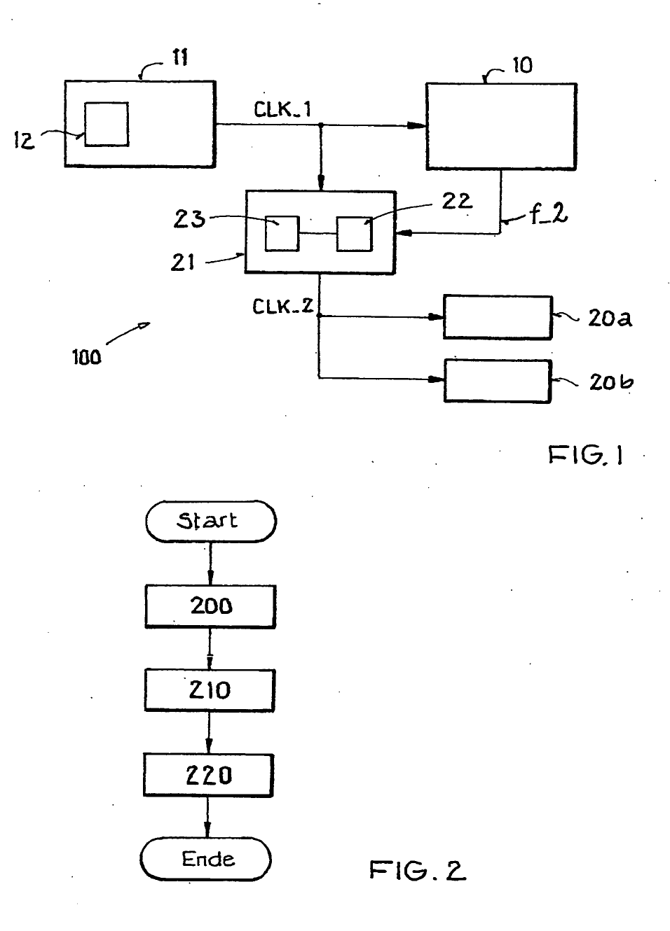

FIG. 1 shows a first embodiment of an electronic circuit 100 in the form of a block diagram. The circuit 100 has a primary circuit 10 that processes at least one information signal with a predefinable frequency. For example, the primary circuit 10 can be an integrated circuit that has the functionality of a transceiver and is used, e.g., in modern mobile telephones to implement a radio interface. In this case, suitable radio signals that are received by the transceiver in various frequency ranges or on the relevant radio channels constitute information signals within the meaning of the present invention.

The primary circuit 10 is supplied by a primary clock generator 11 with a reference clock signal CLK_1, which is obtained within the primary clock generator 11, for example by a quartz crystal oscillator 12. In place of the quartz crystal oscillator 12, the primary clock generator 11 can be provided with any other desired oscillator that can supply a reference clock signal CLK_1 that satisfies the requirements of the primary circuit 10, for example in terms of frequency stability and the like.

In addition to the primary circuit 10, the circuit 100 has two secondary circuits 20a, 20b, preferably also embodied as integrated circuits, which provide, for example, interface or multimedia functionality, thereby complementing the primary circuit 10. The secondary circuits 20a, 20b are connected to the primary circuit 10 through a data bus that is not shown in FIG. 1.

For example, the first secondary circuit 20a can be an interface component that serves to drive a mass storage medium that is also not shown in FIG. 1. The second secondary circuit 20b can be, for example, a control device for a display unit such as an LCD display.

According to the invention, the secondary circuits 20a, 20b are supplied by a peripheral clock generator 21 provided specifically for this purpose with a peripheral clock signal CLK_2 that is generated or derived from the reference clock signal CLK_1 in the peripheral clock generator 21.

To produce the peripheral clock signal CLK_2, the peripheral clock generator 21 can have a voltage-controlled oscillator 22, for example, with which a phase lock loop 23 is associated. Any frequency divider circuits or buffer circuits for buffering the reference clock signal CLK_1 or the peripheral clock signal CLK_2 that may be necessary are not shown in FIG. 1.

In order to ensure that the peripheral clock signal CLK_2 and its harmonics do not interfere with the primary circuit 10 and/or the information signals processed by the primary circuit 10, the frequency of the peripheral clock signal CLK_2 is chosen in accordance with the invention so as to result in the least possible interference with the information signals.

For example, as a criterion for choosing the frequency of the peripheral clock signal CLK_2, it is possible to specify a minimum frequency difference that is to be maintained between the peripheral clock signal CLK_2 or one or more harmonics of the peripheral clock signal CLK_2 and the information signal or information signals, and that must not be violated.

For especially wideband information signals such as, for example, WCDMA signals, a frequency overlap between the information signal and the peripheral clock signal CLK_2 or its harmonics typically cannot be completely avoided. Here, too, in order to nonetheless achieve the least possible interference with such a WCDMA information signal by the peripheral clock signal CLK_2 or its harmonics, the frequency of the peripheral clock signal CLK_2 is chosen according to the invention so as to result in minimal degradation of the signal quality of the WCDMA information signal.

In an embodiment of the present invention, the primary circuit 10 directly drives the voltage-controlled oscillator 22 of the peripheral clock generator 21 in order to set the frequency of the peripheral clock signal CLK_2, as is symbolized in the block diagram in FIG. 1 by the signal identified with the reference symbol f_2.

Another advantage of the present invention is that the frequency of the peripheral clock signal CLK_2 can be chosen as a function of an operating state of the primary circuit 10. By this means, the frequency of the peripheral clock signal CLK_2 can always be matched to a frequency of the information signal that is being processed by the primary circuit 10 at that time. This variant of the invention can be used to particular advantage with primary circuits 10 that are designed as transceivers or receivers, or with other primary circuits 10 that alternately receive or process information signals with different frequencies, i.e. for example in different frequency channels.

By suitable selection of a specific frequency for the peripheral clock signal CLK_2, it is possible to dynamically ensure minimal inherent interference with, e.g., radio reception by the peripheral clock signal CLK_2, for every frequency channel used by the primary circuit 10, thus ensuring maximal sensitivity in receiving a radio signal.

One example of the dynamic selection of a peripheral clock signal CLK_2 with a suitable frequency is explained below on the basis of the flow diagram shown in FIG. 2.

In a first step 200, an operating state of the primary circuit 10 (FIG. 1) is first identified. For example, the operating state can depend on a radio channel currently being used by the primary circuit 10, which defines a specific frequency range for the information signal.

Next, in step 210 (FIG. 2), as a function of the operating state of the primary circuit 10 previously identified in step 200, a frequency is chosen for the peripheral clock signal CLK_2 at which minimal inherent interference with the circuit 100 or the primary circuit 10 is produced by the peripheral clock signal CLK_2.

Thereafter, in step 220, the appropriate frequency is set for the peripheral clock signal CLK_2, which can take place in the manner described above through the selection of a suitable control voltage for the voltage-controlled oscillator 22 of the peripheral clock generator 21.

The method described above can be repeated periodically, with a new frequency preferably being chosen for the peripheral clock signal CLK_2 every time a frequency range of the information signal changes.

In the event that the possible frequency ranges for the information signal are known, in another embodiment of the present invention the frequency of the peripheral clock signal CLK_2 can also be predetermined in a fixed manner, for example by appropriate design of the peripheral clock generator 21, so that the need for control of the peripheral clock generator 21 by the primary circuit 10 is entirely eliminated.

The circuit 100 and the operating method for the circuit permit, in a simple manner, a significant reduction in the inherent interference caused by the peripheral clock signal CLK_2. In contrast to conventional methods, for example those operating on the principle of clock dithering, the implementation of the present invention does not require complex control of the peripheral clock generator 21.

Moreover, the simultaneous supplying of multiple secondary circuits 20a, 20b with the same peripheral clock signal CLK_2 eliminates the complexity of providing multiple peripheral clock generators, each potentially equipped with a clock dithering functionality, for different secondary circuits.

In addition, the choice or setting of the frequency of the peripheral clock signal CLK_2 does not adversely affect the function of the inventive circuit 100, because the peripheral clock signal CLK_2 is only processed by the secondary circuits 20a, 20b. The primary circuit 10, which uses the reference clock signal CLK_1 for purposes that include its receiver or transceiver functionality, e.g. to operate mixers or demodulators and the like, is always supplied with a reference clock signal CLK_1 having the same clock frequency.

Furthermore, the supplying of the reference clock signal CLK_1 to the primary circuit 10 can also take place in the form of an external clock signal (not shown.)

It is also possible in accordance with the invention to provide multiple peripheral clock generators (not shown), each of which is, for example, driven by the primary circuit 10 in such a manner as to output a peripheral clock signal that causes minimal or no inherent interference with the circuit 100.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electronic circuit comprising:
a primary circuit that processes at least one information signal with a predefinable frequency; and
a peripheral clock generator for supplying at least one secondary circuit with a peripheral clock signal,
wherein a frequency of the peripheral clock signal is chosen as a function of the information signal or as a function of a frequency of the information signal.

2. The circuit according to claim 1, wherein the frequency of the peripheral clock signal is chosen such that a frequency of at least one harmonic of the peripheral clock signal does not fall below a predefinable frequency difference from the frequency of the information signal.

3. The circuit according to claim 1, wherein a primary clock generator supplies the primary circuit with a reference clock signal.

4. The circuit according to claim 3, wherein the primary clock generator has an oscillator or a quartz crystal oscillator.

5. The circuit according to one of claim 3, wherein the primary clock generator has a phase lock loop.

6. The circuit according to claim 1, wherein the peripheral clock generator has a voltage-controlled oscillator (22).

7. The circuit according to claim 6, wherein the peripheral clock generator has a phase lock loop (23).

8. The circuit according to claim 1, further comprising at least one secondary circuit.

9. The circuit according to claim 8, wherein the peripheral clock signal is supplied to at least two secondary circuits.

10. A method for operating an electronic circuit having a primary circuit that processes at least one information signal with a predefinable frequency, and having a secondary clock generator for supplying at least one secondary circuit with a peripheral clock signal, wherein a frequency of the peripheral clock signal is chosen as a function of the information signal, in particular as a function of a frequency of the information signal.

11. The method according to claim 10, wherein the frequency of the peripheral clock signal is specified by the primary circuit.

12. The method according to claim 11, wherein the frequency of the peripheral clock signal is chosen as a function of an operating state of the primary circuit.
